(19) United States
(12) Patent Application Publication
(10) Pub. No.: US 2009/0231296 A1
(43) Pub. Date: Sep. 17, 2009

(54) REMOTE CONTROL TRANSMITTER

(75) Inventor: Takuma Besshi, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/401,647

(22) Filed: Mar. 11, 2009

(30) Foreign Application Priority Data
Mar. 12, 2008 (JP) JP 2008-062167

(51) Int. Cl. G06F 3/041

(52) U.S. Cl. 345/173

(57) ABSTRACT

In response to a touch operation performed on an electrostatic touch panel in a liner or curved manner, a controller causes a transmission part to transmit a remote control signal. This structure eliminates the need for pressing operation. Only a touch operation of the electrostatic touch panel for drawing a predetermined trajectory thereon allows remote control of an apparatus. Thus a remote control transmitter simply and securely operable and preventing erroneous operation is provided.

### BACKGROUND OF THE INVENTION

1. Field of the Invention

The present invention relates to a remote control transmitter mainly for use in remote control operation of various types of electronic apparatus.

2. Background Art

In the recent enhancement of multi-functionality of various types of electronic apparatus, such as a television, video, and air conditioner, also a remote control transmitter for remote-controlling such an apparatus has been requested to securely perform various kinds of operation.

A description is provided of such a conventional remote control transmitter, with reference to FIGS. 6 through 9.

In the sectional view among these drawings, the dimension in the thickness direction is enlarged for ease of explanation of the structure.

FIG. 6 is a sectional view of a conventional remote control transmitter. FIG. 7 is a perspective view of the conventional remote control transmitter. With reference to FIGS. 6 and 7, electrostatic touch panel 2 is attached to a hole opened through the top face of case 1 made of an insulating resin, such as a polystyrene resin and an ABS resin. This electrostatic touch panel 2 is formed so that a plurality of strip-shaped current-carrying parts (not shown) are arranged on the top face or both top and bottom faces of a film-shaped sheet at predetermined intervals in the orthogonal directions.

Electrostatic touch panel 2 is housed between top covering 3 and bottom covering 4 both made of an insulating resin. Tail part 2A that has electrodes (not shown) connected to the ends of the plurality of current-carrying parts of electrostatic touch panel 2 extends outwardly from the bottom face of bottom covering 4 on the right side thereof.

A plurality of wiring patterns (not shown) are formed on the top and bottom faces of wiring board 5. Further, switch contact 6, such as a push switch, is mounted on the top face of wiring board 5. The bottom face of bottom covering 4 is in contact with push button 6A protruding from the top face of switch contact 6. Further, electrostatic touch panel 2 is electrically connected to the wiring patterns on wiring board 5 via tail part 2A, a connector, or the like.

Operating body 7 made of a rubber or the like has a dome-shaped thin part formed in a lower portion thereof. The top face of operating body 7 protrudes from a through-hole through the top face of case 1 so as to be vertically movable. Further, on the bottom face of operating body 7, movable contact 7A is provided so as to face a plurality of fixed contacts 5A formed on the top face of wiring board 5, with a predetermined space provided therebetween.

On the top and bottom faces of wiring board 5, transmission part 8 and controller 9 are formed. The transmission part formed of a light-emitting diode (LED), for example, transmits a remote control signal. The controller formed of a microcomputer, for example, is connected to transmission part 8, electrostatic touch panel 2, switch contact 6, and the plurality of fixed contacts 5A, via the wiring patterns. Cover 10 made of an insulating resin covers the bottom face of case 1.

While a conventional remote control transmitter structured as above is directed toward an electronic apparatus to be operated, the top face of predetermined operating body 7 is pressed with a finger. This operation elastically deforms the dome-shaped thin part and moves operating body 7 downwardly. Thus movable contact 7A on the bottom face of the operating body is brought into contact with the plurality of fixed contacts 5A. Thereby, the plurality of fixed contacts 5A are brought into electrical contact with each other via movable contact 7A. In response to this electrical contact, controller 9 causes transmission part 8 to transmit an infrared remote control signal to the electronic apparatus. For example, a television is powered on/off or a channel is changed over by such remote control.

FIG. 8 is a diagram showing a menu that is displayed on the screen of an electronic apparatus to be controlled by the conventional remote control transmitter. With reference to FIG. 8, while an apparatus menu, for example, is displayed on display screen 31 of electronic apparatus 30 to be remote-controlled, the electrostatic touch panel is touch-operated so that a finger is in contact with the top face of top covering 3 and is horizontally and vertically slid thereon. With this operation, the finger is charged with a part of the electric charge on electrostatic touch panel 2, which changes the capacitance of the current-carrying parts in the touch-operated portion. According to this change, controller 9 detects which portion of electrostatic touch panel 2 is touch-operated.

Then, controller 9 causes transmission part 8 to transmit a remote control signal corresponding to this finger movement to the apparatus. Thus, for example, pointer 32 or the like displayed on display screen 31 moves vertically or horizontally, in the direction of the finger movement, so that an item in the apparatus menu, for example, is selected.

Further, while pointer 32 or the like is placed on the desired item of the apparatus menu, the top face of top covering 3 is pressed. This operation moves electrostatic touch panel 2 and bottom covering 4 downwardly, and the bottom face of bottom covering 4 presses push button 6A of switch contact 6. Thus electrical contact is established in switch contact 6. Controller 9 detects the electrical contact and causes transmission part 8 to transmit a remote control signal. Then, a next menu, such as an apparatus operation menu, is displayed on the display screen of the electronic apparatus.

FIG. 9 is a drawing showing the next menu displayed on the screen of the electronic apparatus to be controlled by the conventional remote control transmitter. With reference to FIG. 9, when the top face of top covering 3 is vertically and horizontally touch-operated again with a finger in this state, controller 9 causes transmission of a remote control signal corresponding to this finger movement. For example, cursor 33 or the like displayed on the display screen is vertically and horizontally moved so that an item in the operation menu, for example, is selected. Pressing operation performed again in this state establishes electrical contact in switch contact 6, and causes transmission of a remote control signal. For example, such operations as the playback and fast forward of a video tape, a disk, or the like are performed.

In this manner, in the conventional remote control transmitter, pressing operation of a plurality of operating bodies 7 allows remote control of various functions, such as a power-on/off and channel selection, of an apparatus. Further, repeated touching and pressing operation of electrostatic touch panel 2 allows sequential changeover in the apparatus menu, operation menu, or the like displayed on the display screen. For each operation of an apparatus, these selecting and determining operations are repeated so that the apparatus is remote-controlled.

For example, Japanese Patent Unexamined Publication No. 2007-141269 is known as the information about conventional arts related to this invention.

However, in the above conventional remote control transmitter, the following actions are performed for such operations as a playback and fast forward shown in the apparatus operation menu, for example. First, the finger in contact with electrostatic touch panel 2 is moved so that an item in the operation menu, for example, is selected by touch operation. Next, electrostatic touch panel 2 is pressed for remote control of the apparatus. Such a complicated operation easily causes erroneous operation.

### SUMMARY OF THE INVENTION

The present invention provides a remote control transmitter simply and securely operable without erroneous operation.

In the remote control transmitter, in response to a touch operation performed on an electrostatic touch panel in a liner or curved manner, a controller causes a transmission part to transmit a remote control signal. In response to only a touch operation of the electrostatic touch panel for drawing a predetermined linear or curved trajectory thereon, the controller causes transmission of a remote control signal corresponding to this touch operation and allows remote control of an apparatus. This structure eliminates the need for pressing operation. Thus a remote control transmitter simply and securely operable and preventing erroneous operation can be provided.

### BRIEF DESCRIPTION OF THE DRAWINGS

FIG. 1 is a sectional view of a remote control transmitter in accordance with a first exemplary embodiment of the present invention.

FIG. 2 is an exploded perspective view of the remote control transmitter in accordance with the first exemplary embodiment.

FIG. 3 is a diagram showing a menu that is displayed on the screen of an electronic apparatus to be controlled by the remote control transmitter in accordance with the first exemplary embodiment.

FIG. 4A is a diagram showing a trajectory drawn by a finger on an electrostatic touch panel of the remote control transmitter in accordance with the first exemplary embodiment.

FIG. 4B is a diagram showing a trajectory drawn by a finger on the electrostatic touch panel of the remote control transmitter in accordance with the first exemplary embodiment.

FIG. 4C is a diagram showing a trajectory drawn by a finger on the electrostatic touch panel of the remote control transmitter in accordance with the first exemplary embodiment.

FIG. 4D is a diagram showing a trajectory drawn by a finger on the electrostatic touch panel of the remote control transmitter in accordance with the first exemplary embodiment.

FIG. 5A is a diagram showing a trajectory drawn by a finger on the electrostatic touch panel of the remote control transmitter in accordance with the first exemplary embodiment.

FIG. 5B is a diagram showing a trajectory drawn by a finger on the electrostatic touch panel of the remote control transmitter in accordance with the first exemplary embodiment.

FIG. 6 is a sectional view of a conventional remote control transmitter.

FIG. 7 is a perspective view of the conventional remote control transmitter.

FIG. 8 is a diagram showing a menu that is displayed on the screen of an electronic apparatus to be controlled by the conventional remote control transmitter.

FIG. 9 is a diagram showing a next menu that is displayed on the screen of the electronic apparatus to be controlled by the conventional remote control transmitter.

### DETAILED DESCRIPTION OF THE INVENTION

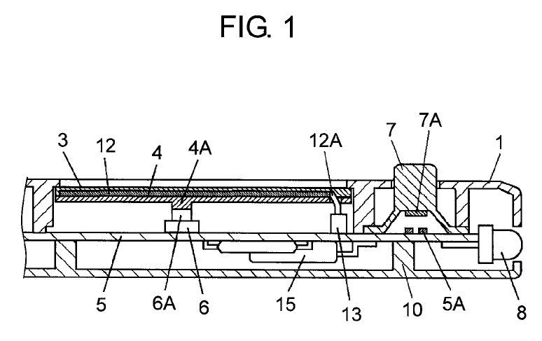

Hereinafter, a description is provided of a first exemplary embodiment of the present invention, with reference to FIGS. 1 through 3, FIGS. 4A through 4D, and FIGS. 5A and 5B.

In the sectional view among these drawings, the dimension in the thickness direction is enlarged for ease of explanation of the structure.

The elements similar to those described in Background art have the same reference marks, and the descriptions of those elements are simplified.

### First Embodiment

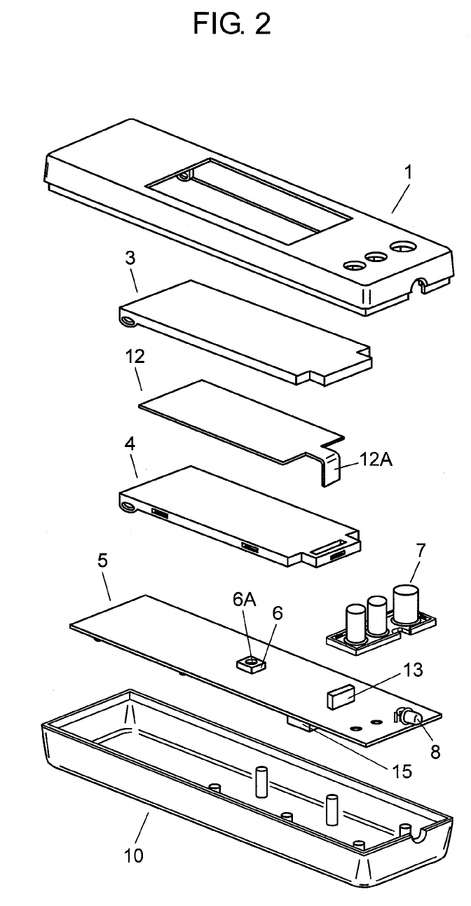

FIG. 1 is a sectional view of a remote control transmitter in accordance with the first exemplary embodiment of the present invention. FIG. 2 is an exploded perspective view of the remote control transmitter in accordance with the first exemplary embodiment. With reference to FIGS. 1 and 2, electrostatic touch panel 12 is attached to a hole opened through the top face of case 1 made of an insulating resin, such as a polystyrene resin and an ABS resin. This electrostatic touch panel 12 is formed so that a plurality of strip- or square-shaped current-carrying parts (not shown) are arranged on the top face or both top and bottom faces of a film-shaped sheet at predetermined intervals in the orthogonal directions.

Electrostatic touch panel 12 is housed between top covering 3 and bottom covering 4 both made of an insulating resin. Tail part 12A that has electrodes (not shown) connected to the ends of the plurality of current-carrying parts of electrostatic touch panel 12 extends outwardly from the bottom face of bottom covering 4 on the right side thereof.

Wiring board 5 is made of a paper phenol, glass epoxy, or the like. On the top and bottom faces of the wiring board, a plurality of wiring patterns (not shown) are formed of a copper foil, or the like. Further, switch contact 6, such as a push switch, is mounted on the top face of wiring board 5. Protrusion 4A on the bottom face of bottom covering 4A is in contact with push button 6A protruding from the top face of switch contact 6. Further, electrostatic touch panel 12 is electrically connected to the wiring patterns on wiring board 5 via tail part 12A, connector 13, or the like.

Operating body 7 made of a rubber, elastomer, or the like has a dome-shaped thin part formed in a lower portion thereof. The top face of operating body 7 protrudes from a through-hole through the top face of case 1 so as to be vertically movable. Further, on the bottom face of operating body 7, movable contact 7A is provided so as to face a plurality of fixed contacts 5A formed on the top face of wiring board 5, with a predetermined space provided therebetween.

On the top and bottom faces of wiring board 5, transmission part 8 and controller 15 are formed. The transmission part formed of an LED, for example, transmits a remote control signal. The controller formed of a microcomputer, for example, is connected to transmission part 8, electrostatic touch panel 12, switch contact 6, and the plurality of fixed contacts 5A, via the wiring patterns. Cover 10 made of an insulating resin covers the bottom face of case 1.

While a remote control transmitter of the first exemplary embodiment of the present invention structured as above is directed toward an electronic apparatus to be operated, the top face of predetermined operating body 7 is pressed with a finger. This operation elastically deforms the dome-shaped thin part and moves operating body 7 downwardly. Thus movable contact 7A on the bottom face of the operating body is brought into contact with the plurality of fixed contacts 5A. Thereby, the plurality of fixed contacts 5A are brought into electrical contact with each other via movable contact 7A. In response to this electrical contact, controller 15 causes transmission part 8 to transmit an infrared remote control signal to the electronic apparatus. For example, a television is powered on/off or a channel is changed over by such remote control.

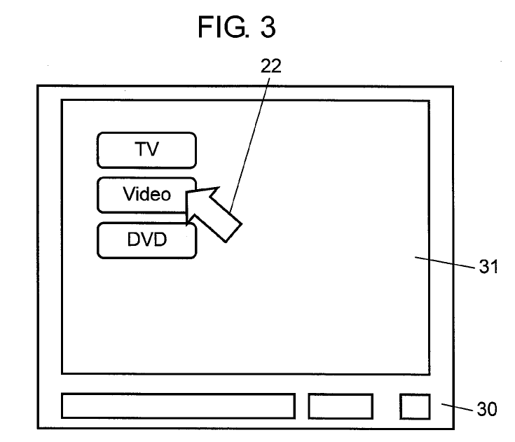

FIG. 3 is a diagram showing a menu that is displayed on the screen of an electronic apparatus to be controlled by the remote control transmitter of the first exemplary embodiment of the present invention. With reference to FIG. 3, while an apparatus menu, for example, is displayed on display screen 31 of electronic apparatus 30 to be remote-controlled, the electrostatic touch panel is touch-operated so that a finger is in contact with the top face of top covering 3 and is horizontally and vertically slid thereon. With this operation, the finger is charged with a part of the electric charge on electrostatic touch panel 12, which changes the capacitance of the current-carrying parts in the touch-operated portion. According to this change, controller 15 detects which portion of electrostatic touch panel 12 is touch-operated.

Then, controller 15 causes transmission part 8 to transmit a remote control signal corresponding to this finger movement to the apparatus. Thus, for example, pointer 22 or the like displayed on display screen 31 moves vertically or horizontally, in the direction of the finger movement, so that an item in the apparatus menu, for example, is selected.

Further, while pointer 22 or the like is placed on the desired item of the apparatus menu, the top face of top covering 3 is pressed. This operation moves electrostatic touch panel 12 and bottom covering 4 downwardly, and protrusion 4A on the bottom face of bottom covering 4 presses push button 6A of switch contact 6. Thus electrical contact is established in switch contact 6. Controller 15 detects the electrical contact and causes transmission part 8 to transmit a remote control signal. Thus an apparatus to be remote-controlled is selected.

In short, pressing operation of a plurality of operating bodies 7 allows remote control of respective functions of an apparatus, such as a powering on/off and channel selection. Touching and pressing operation of electrostatic touch panel 12 allows selection and determination of one of the apparatuses shown on display screen 31.

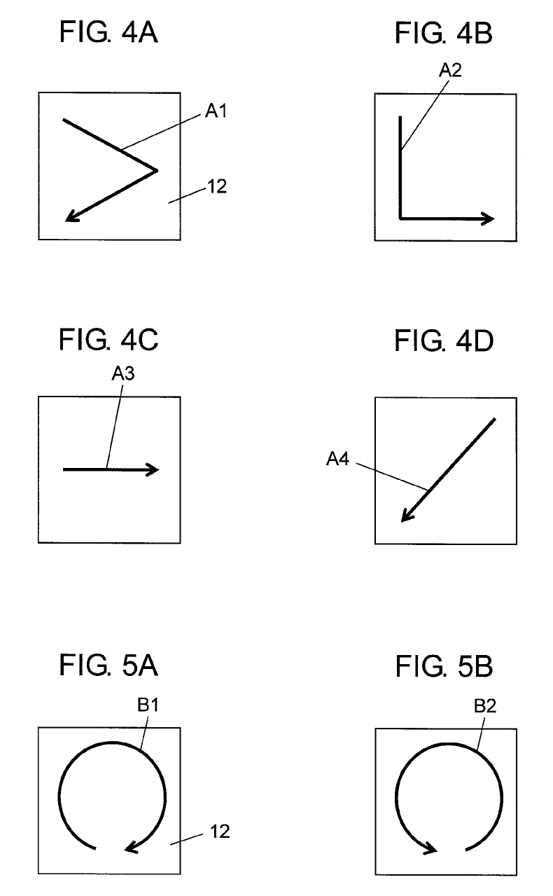

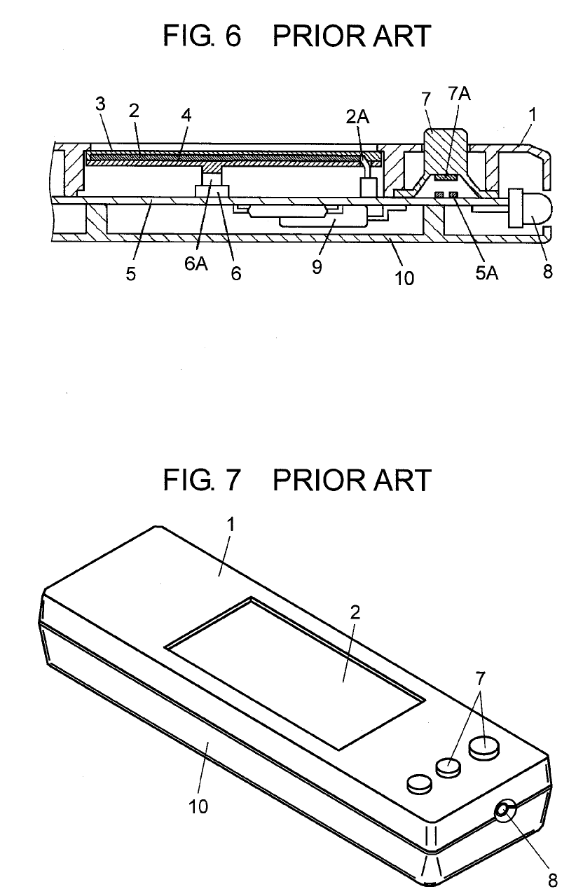

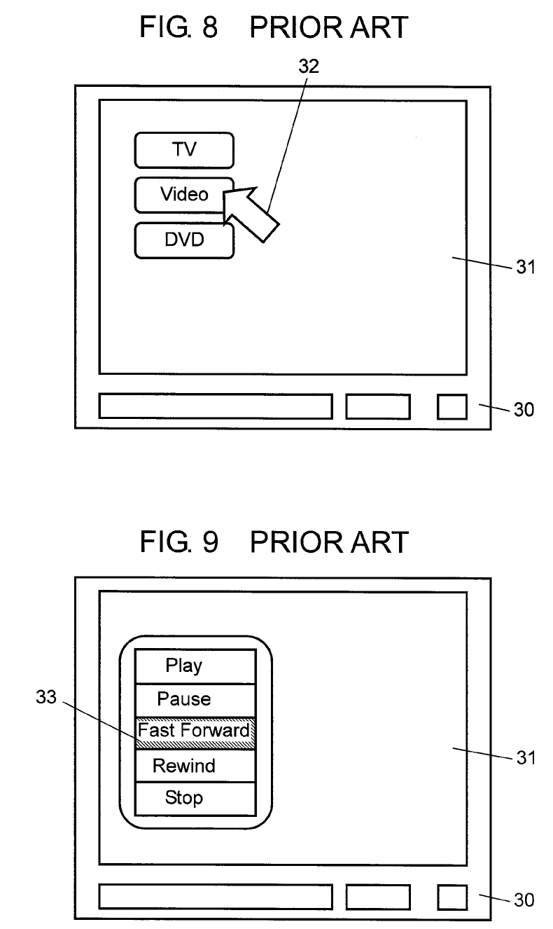

FIGS. 4A through 4D, 5A, and 5B are diagrams showing trajectories drawn by a finger on the electrostatic panel of the remote control transmitter of the first exemplary embodiment of the present invention.

After one of the apparatuses shown on display screen 31 is determined, the top face of top covering 3 is touched with a finger so that the finger is horizontally and vertically moved in a linear or curved manner. For example, as shown in FIG. 4A, the electrostatic touch panel is touch-operated so that the finger is moved toward the bottom right and sequentially toward the bottom left. This touch operation changes the capacitance of electrostatic touch panel 12 in the touched portion. According to this change in the capacitance of electrostatic touch panel 12, controller 15 detects that electrostatic touch panel 12 is touch-operated so that a trajectory A1 is drawn thereon. The controller also checks this trajectory A1 against a plurality of pre-stored trajectories. For example, in a case of the trajectory A1, controller 15 causes transmission of a remote control signal for playback to the apparatus. Thus the playback of a video tape, disk, or the like is performed in the apparatus.

In another case, as shown in FIG. 4B, electrostatic touch panel 12 is touch-operated so that the finger is moved in the downward direction and sequentially in the right direction to draw an L-shaped trajectory A2. In this case, controller 15 detects this trajectory A2, checks the trajectory A2 against the stored trajectories, and causes transmission part 8 to transmit a remote control signal for pausing to the apparatus.

Similarly, in a case of a trajectory A3 showing a movement from the left to the right in the central portion of electrostatic touch panel 12 as shown in FIG. 4C, controller 15 causes transmission of a remote control signal for fast-forwarding. In a case of a trajectory A4 showing a movement from the top right to the bottom left as shown in FIG. 4D, the controller causes transmission of a remote control signal for stopping. Accordingly, a video tape, disk, or the like is fast-forwarded or stopped.

Further, as shown in FIG. 5A, in a case of touch operation where the finger is continuously moved clockwise to draw a ring shape, controller 15 detects this ring-shaped trajectory B1, checks the trajectory against the stored trajectories, and detects the number of rotations. Then, for example, a remote control signal for increasing sound volume is transmitted to the apparatus repeatedly at the number of times equal to the number of rotations.

As shown in FIG. 5B, in another case of touch operation where the finger is continuously moved counterclockwise to draw a ring-shaped trajectory B2, controller 15 causes transmission part 8 to transmit a remote control signal for decreasing sound volume to the apparatus repeatedly at the number of times equal to the number of rotations.

In this manner, electrostatic touch panel 12 is touch-operated so that linear trajectories, such as the trajectories A1 through A4, or curved trajectories, such as the trajectories B1 and B2, are drawn. Further, controller 15 detects such a predetermined trajectory, and checks the trajectory against the plurality of pre-stored trajectories. Transmission part 8 transmits remote control signals corresponding to these touch operations. Thus, with only a touch operation for drawing predetermined trajectories, various kinds of remote control operation of a video tape, disk, apparatus, or the like can be performed.

In other words, in response to only a touch operation of electrostatic touch panel 12 for drawing a predetermined linear or curved trajectory thereon, controller 15 causes transmission of a remote control signal corresponding to the touch operation and allows remote control of the apparatus. This structure eliminates the need for pressing operation and thus prevents occurrence of erroneous operation. Further, remote control can be ensured by a simple operation of only touching.

The above descriptions have been provided for a structure where in response to a touch operation performed on electrostatic touch panel 12 in a linear or curved manner, controller 15 detects a predetermined trajectory of this touch operation, checks the trajectory against a plurality of pre-stored trajectories, and causes transmission of a remote control signal for a corresponding operation. However, the present invention can be implemented in a structure where the remote control transmitter transmits a trajectory of the touch operation as a predetermined remote control signal without change, and the apparatus on the receiver side checks the remote control signal against a plurality of trajectories stored therein and performs a corresponding operation.

Further, while electrostatic touch panel 12 is touch-operated in a liner or curved manner, controller 15 or the apparatus on the receiver side may ignore any operation other than the above touch operation. This structure can prevent erroneous operation of the apparatus, even when electrostatic touch panel 12 or operating body 7 is inadvertently operated. For example, during a touch operation with a forefinger for drawing the trajectory A1 or B1, a middle finger inadvertently touches the other portion of electrostatic touch panel 12. In such a case, controller 15 ignores this inadvertent operation, and does not cause transmission of a remote control signal corresponding to this operation. Alternatively, the apparatus on the receiver side ignores this operation and only performs the operation corresponding to the predetermined trajectory. This structure can prevent erroneous operation of the apparatus and provide a more user-friendly operation.

In this manner, in accordance with the first exemplary embodiment, controller 15 causes transmission part 8 to transmit a remote control signal, in response to a touch operation of electrostatic touch panel 12 performed in a linear or curved manner. This structure eliminates the need for pressing operation. Only a touch operation of electrostatic touch panel 12 for drawing a predetermined trajectory allows remote control of the apparatus. Thus a remote control transmitter simply and securely operable and preventing erroneous operation can be provided.

The above descriptions have been provided for a structure where a push switch is mounted on the top face of wiring board 5 to form switch contact 6. However, the present invention can be implemented in another structure using various types of switch contact. For example, a plurality of fixed contacts are provided on the top face of wiring board 5. Further, an operating body similar to operating body 7 may be formed above the fixed contacts so that a movable contact formed on the bottom face thereof faces the fixed contacts. Alternatively, a dome-shaped movable contact made of a conductive sheet metal may be placed on the fix contacts on the top face of wiring board 5.

The above descriptions have been provided for a structure where transmission part 8 is formed of an LED, for example, and transmits an infrared remote control signal to the electronic apparatus. However, the transmission part may be formed of an antenna, and a remote control signal of a radio wave may be transmitted.

The remote control transmitter of the present invention is simply and securely operable without erroneous operation, and is useful mainly for operating various types of electronic apparatus.

What is claimed is:

1. A remote control transmitter comprising:
an electrostatic touch panel attached to a top face of a case; and
a controller coupled to the electrostatic touch panel,
wherein in response to a touch operation performed on the electrostatic touch panel in a linear or a curved manner, the controller causes transmission of a remote control signal.
